(19) United States
(12) Patent Application Publication
(10) Pub. No.: US 2019/0056257 A1
(43) Pub. Date: Feb. 21, 2019

(54) METHOD FOR DETERMINING DENSITY OF A MEDIUM IN A TANK OF A HYBRID TANK MEASUREMENT SYSTEM

(71) Applicant: Endress+Hauser SE+Co. KG, Maulburg (DE)

(72) Inventor: Björn Bellmann, Freiburg (DE)

(21) Appl. No.: 16/101,703

(22) Filed: Aug. 13, 2018

(30) Foreign Application Priority Data
Aug. 16, 2017 (DE) 10 2017 118 684.0

(51) Int. Cl. G01F 23/26; G01F 23/14; G01F 23/284

(52) U.S. Cl. CPC G01F 23/26; G01F 23/0069; G01F 23/284; G01F 23/14

(57) ABSTRACT

The application discloses a method for determining density of a medium in a tank of a hybrid tank measurement system having at least two pressure sensors for determining pressure measurement values, wherein the pressure sensors are specified for mutually differing pressure measuring ranges each having an absolute measurement error, and wherein the method includes: registering at least one pressure measurement value with the two pressure sensors; forming a pressure difference magnitude from the registered pressure measurement values; comparing the pressure difference magnitude with a threshold value; and determining the density of the medium based on the comparing of the difference values with the threshold value.

### CROSS-REFERENCE TO RELATED APPLICATION

The present application is related to and claims the priority benefit of German Patent Application No. 10 2017 118 684.0, filed on Aug. 16, 2017, the entire contents of which are incorporated herein by reference.

### TECHNICAL FIELD

The present disclosure relates to a method for determining density of a medium in a tank of a hybrid tank measurement system and a hybrid tank measurement system for determining density of the medium in the tank.

### BACKGROUND

The American Petroleum Institute (API) brings together in the Manual of Petroleum Measurement (MPM) standards, plus all important regulations and information, which, among other things, are applicable for the topic of inventory management in the oil and gas industry. This information has been placed in international standards and is internationally recognized. Hybrid tank measurement systems (HTMS) are described in API standard MPM 3.6, as used for the standard, ISO15169, published December 2003. This standard describes a procedure for determining density of a medium in a tank based on a combination of measured values. To this end, the standard distinguishes between two variants (modes): HTMS modes 1 and 2. Mode 1 uses a pressure sensor near to the tank floor for continuously determining density via the hydrostatic pressure. In the other variant (mode 2), a second pressure sensor is attached to the roof of the tank, in order to determine the vapor density there. Via the known volume, then the mass fraction of the medium in the gas phase can be determined, so that a more exact knowledge concerning the tank contents can be provided. Moreover, from the vapor density, the measured density and the measured value of the pressure sensor can be corrected. Without the second pressure sensor, the practice is to assume a constant value. In the present instance, the method of HTMS mode 1 will be used as calculational basis, since mode 2 is only a special case in the form of a further development of mode 1.

For determining density, an HTMS is composed, usually, of a fill level sensor, also called an automatic tank gauge, a temperature sensor, also called an automatic tank thermometer, as well as one or more pressure sensors. If the density is to be determined via the hydrostatic pressure (mode 1), then at least one additional pressure sensor is necessary. In such case, there is an antagonism between an as large as possible measuring range and an as exact as possible measurement. Pressure measurement cells with a large measuring range have a greater absolute measurement error than pressure measurement cells with a lesser measuring range. A greater absolute measurement error has in the case of low pressure, i.e. a low fill level, a major influence on the accuracy of the density determination and thus of the mass calculation. A lesser measuring range can, in given cases, however, not cover the entire possible fill level of the tank.

### SUMMARY

An object of the present disclosure thus is to determine density more exactly and to be able to adapt better to the particular case of application.

The object is achieved by a method for determining density of a medium in a tank of a hybrid tank measurement system and by a hybrid tank measurement system.

As regards the method, the object is achieved by a method for determining density of a medium in a tank of a hybrid tank measurement system having at least two pressure sensors for determining, in each case, at least one pressure measurement value, wherein the pressure sensors are specified for mutually differing pressure measuring ranges with absolute measurement errors Δpx and Δpy, respectively, and wherein the method for determining density comprises steps as follows:

registering, in each case, at least one pressure measurement value px and py, respectively, with the two pressure sensors;

forming a difference value magnitude |px−py| from the registered pressure measurement values px, py;

comparing the formed difference value magnitude |px−py| with a threshold value; and

determining density of the medium based on the comparing of the difference values with the threshold value.

The method enables use of a pressure sensor cascade, i.e. a plurality of pressure sensors, instead of just one pressure sensor, for ascertaining the density. According to the present disclosure, the applied pressure sensors are switched between as a function of the comparing of the difference value magnitude with the threshold value, in order to perform the determining, or calculating, of the density. In such case, when more than two pressure sensors are applied, the pressure measurement values of those two pressure sensors are evaluated, which have measuring ranges nearest to the current tank level, or pressure measurement value. For the density calculation, there results thus the advantages that the measuring range can be expanded to almost the complete tank and/or that the error can be reduced.

An advantageous form of embodiment of the present disclosure is that the comparing of the formed difference value magnitude |px−py| with the threshold value Eth and the determining of the density of the medium are performed in such a manner that, in the case, in which |px−py|>Eth, the pressure measurement value of the pressure sensor with the greater absolute measurement error is used for determining density and, in the case, in which |px−py|≤Eth, the pressure measurement value of the pressure sensor with the lesser absolute measurement error is used for determining density.

Another advantageous form of embodiment of the present disclosure provides that an offset value O is used in the comparing of the formed difference value magnitude |px−py| with the threshold value Eth and the offset value O represents a deviation of at least one pressure measurement value of the two pressure sensors in a reference point, preferably a zero-point. Especially, the form of embodiment can provide that the comparing of the formed difference value magnitude |px−py| with the threshold value Eth, in which also the offset value O is used, and the determining of the density of the medium are performed in such a manner that in the case, in which ∥px−py|−O|>Eth, the pressure measurement value of the pressure sensor with the greater absolute measurement error is used for determining density and in the case, in which ∥px−py|−O|≤Eth, the pressure measurement value of the pressure sensor with the lesser absolute measurement error is used for determining density.

Another advantageous form of embodiment of the present disclosure provides that the lesser absolute measurement error is used as threshold value Eth.

Another advantageous form of embodiment of the present disclosure provides that the determining of density of the medium is performed based on the following Equation:

ρ=px/(g*h), or ρ=py/(g*h),

wherein g is acceleration of gravity and h is fill level of the tank. Especially, the form of embodiment can provide that the fill level h is corrected by an offset Z of the corresponding pressure sensor 2.

In turn, an advantageous form of embodiment of the present disclosure provides that the absolute measurement error Δpx, Δpy for the particular pressure measuring range of the particular pressure sensor is specified in such a manner that at least one reference accuracy E1 and one environmental temperature influence variable E2 of the particular pressure sensor are used for the absolute measurement error, preferably according to the formula: Δpx, or Δpy=±√(E1²+E2²). Especially, the form of embodiment can provide that the reference accuracy E1 includes a non-linearity according to DIN EN 61298-2:2009-08 in the particular pressure measuring range according to the limiting point method of DIN EN 60770:2011-09, and wherein the non-linearity is influenced by a hysteresis according to DIN EN 61298-2:2009 and a non-reproducibility according to DIN EN 61298-2:2008.

In turn, an advantageous form of embodiment of the present disclosure provides that the environmental temperature influence variable E2 includes at least one influence of an ambient temperature according to IEC 61298-3:2009-08 at a reference temperature, preferably 25° C., according to DIN 16086:2006-01.

As regards the system, the object is achieved by a hybrid tank measurement system for determining density of a medium in a tank and adapted to perform the method as described in at least one of the above described forms of embodiment.

### BRIEF DESCRIPTION OF THE DRAWINGS

The present disclosure will now be explained in greater detail based on the appended drawing, the figures of which show as follows:

FIG. 1 shows a schematic representation of an instrument-equipped tank, e.g. a hybrid tank measurement system known from the state of the art,

FIG. 2 shows a hybrid tank measurement system of the present disclosure, and

FIG. 3 shows a schematic representation of the method of the present disclosure.

### DETAILED DESCRIPTION

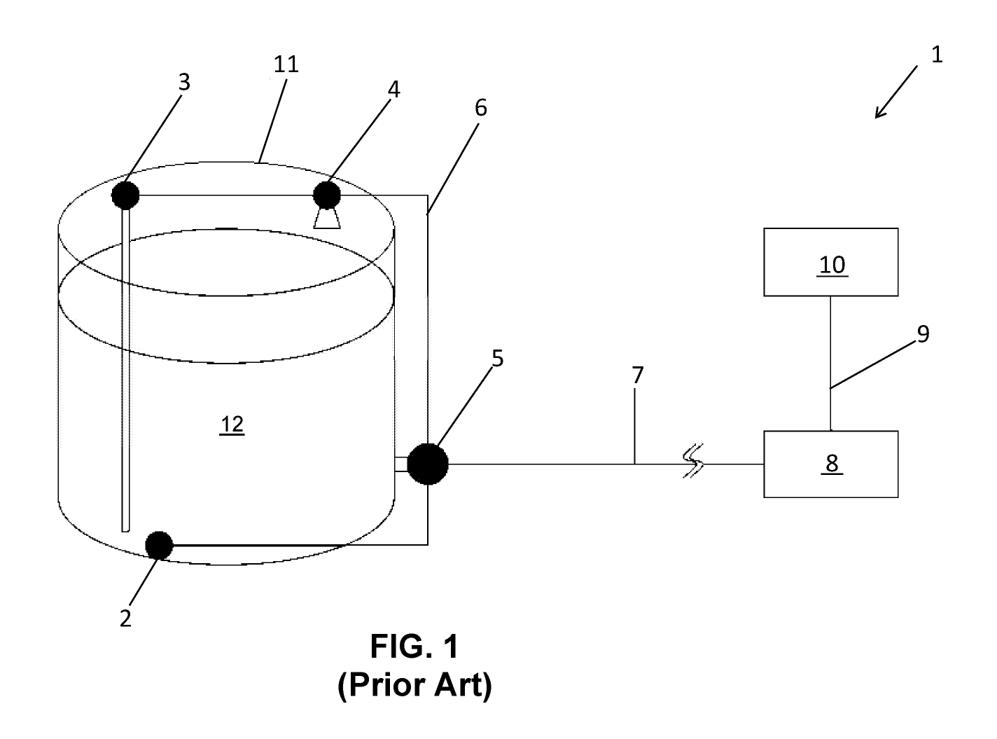

FIG. 1 shows a schematic representation of an instrument-equipped tank in the form of a hybrid tank measurement system 1 known from the state of the art. Such includes a tank 11 filled with a medium 12, a (single) pressure sensor 2, a temperature sensor 3, a fill level sensor 4, and a so-called hybrid processor 5, 8, such as described in the API standard MPM 3.6, section 6.5. Such includes especially that the hybrid processor 5, 8 is equipped to collect and to represent data and/or to perform calculations. The hybrid processor can comprise, for example, a tank-side monitor 5, and/or a tank scanner 8 of the firm, Endress+Hauser. Furthermore, the hybrid tank measurement system can optionally have a superordinated unit 10, for example, a SCADA unit.

For determining temperature, temperature sensors 3 can be applied, which register the average temperature of the medium 12, for example, based on one or more PT100 elements. For example, temperature sensors of type, Prothermo NMT539, of the Endress+Hauser group can be used. These temperature sensors have an accuracy of ±0.1° C.

For determining fill level, fill level sensors 4 can be used, which work according to the so-called “time of flight” principle, thus by measuring travel time of electromagnetic waves. The devices 4 work with different frequencies and so cover different ranges of up to 70 m with an accuracy of ±0.5 mm. On the other hand, also servo fill level sensors, for example, of type Proservo NMS of the Endress+Hauser group, can be used. These achieve an accuracy of ±0.4 mm with a range of to 40 m. A float or displacer (displacer), hung on a wire, follows the fill level in this case. The length of the wire is determined by a stepper motor. In such case, it is, moreover, possible to ascertain the density of the medium, however, this is too inaccurate for application in tank gauging applications according to corresponding standards.

The temperature sensor 3, the pressure sensor 2 and the fill level sensor 4 are connected via a first bus 6, for example, a HART bus, with the tank-side monitor 5 for data transmission. The tank-side monitor 5 is, in turn, connected via a second bus 7, preferably a fieldbus, for example, a Modbus, with the tank scanner 8 for data transmission.

For determining the hydrostatic pressure phyd, capacitive or resistive pressure sensors 2 can be applied. For example, pressure sensors 2 of type Cerabar S of the Endress+Hauser group can be used. The hydrostatic pressure phyd is composed of the ambient pressure pA and the gravitational pressure p of a medium, which acts supplementally on an area A due to the force of gravity FG. For further consideration, the ambient pressure and a possible steam, or vapor, pressure within a closed tank are neglected, so that the determining of density is, in principle, accomplished based on the following Equation:

ρ=p/(g*h),

wherein ρ corresponds to the density, p to the pressure measurement value, g to the acceleration of gravity and h to the fill level, i.e. the level of substance in the tank.

Usually, the installed position of the pressure sensor 2 is not the same as the zero of fill level. Depending on the HTMS mode, there result, consequently, calculational formulas modified according to the above mentioned API standard. These calculational formulas take many other factors into consideration. The particular correction and the calculating of the volume-, or mass of a medium located in the tank based on the density should, due to its complexity, not be explored here in greater detail, but, instead, reference is made to the standard, ISO15169, of December 2003.

The evaluation of the collected sensor measured values is performed, on the one hand, by the tank-side monitor 5 and, on the other hand, by the tank scanner 8. The tank-side monitor 5 serves, firstly, for collecting the data directly at the tank. It is, moreover, possible here to configure the tank-side monitor 5 as a part of the connected sensors 2, 3 or 4. The collected data can then be forwarded for additional processing via a third bus 9, especially a fieldbus, to the superordinated unit 10, for example, a Supervisory Control and Data Acquisition unit (SCADA unit) or the like. The tank scanner 8 can be accommodated, for example, in server cabinets and thus be arranged separated from the tank 11 and the tank-side monitor 5. The data here can be conditioned using corresponding correction factors.

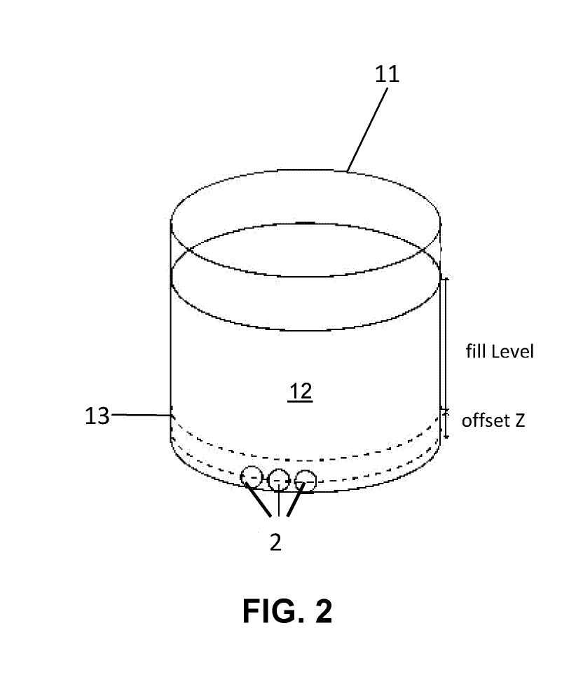

The system 1 of the present disclosure shown in FIG. 2 includes, in such case, in contrast to the HTMS illustrated in FIG. 1, a plurality of pressure sensors 2 located in the floor region of the tank and having different measuring-, i.e. pressure, ranges, which partially overlap. The selection of the pressure ranges occurs, in such case, principally via the tank height and therewith the expected maximum pressure. The individual pressure sensors 2 have, in subregions, characteristic curves, or lines, which are parallel to one another. Furthermore, the individual pressure sensors 2 have absolute measurement errors Δpx, Δpy, Δpz. The pressure sensors 2 can, for example, be connected with the tank 11 via a hub with a valve placed in between. In this way, a plurality of sensors can be connected at a single tank connection. Also, a retrofitting of existing tank farms is possible in this way.

For an exact calculating of the density, the exact position of the individual pressure sensors 2 relatively to a reference point, for example, a zero 13, is required, in order to associate the measured pressure measurement value px, py, pz with the correct fill level. The zero as reference point corresponds, usually, not to the tank floor, since this has irregularities or other volume disturbing factors, which means no exact zero in the case of a completely empty tank, so that there is no linear relationship between fill level and volume. Rather, used as zero is a value established by the tank builder in consultation with the tank farm operator, so that basically a virtual zero, or reference mark, is used for the purposes of calculation. The difference between the exact position of the individual pressure sensors 2 and the reference point is used as an offset Z for the fill level. Preferably, each pressure sensor 2 must be provided separately with this offset Z, since it cannot be assumed that the pressure sensors are installed at equal heights. The idea of the present disclosure functions, in principle, also without providing the pressure sensors with the offset Z, however, then greater measurement errors can be experienced.

Due to the fact that the individual pressure sensors 2 have parallel characteristic curves in the mentioned subregions, differences formed from different pressure measurement values px, py, pz within the subregions do not change. Now, if a pressure sensor 2 reaches its measuring range end value, a saturation occurs, so that the difference value magnitude changes. This means that the sensor signal of the pressure sensor, which has reached its measuring range end value, remains constant, in spite of rising fill level. Furthermore, this leads to the fact that the difference value magnitude changes, so that this change can be detected.

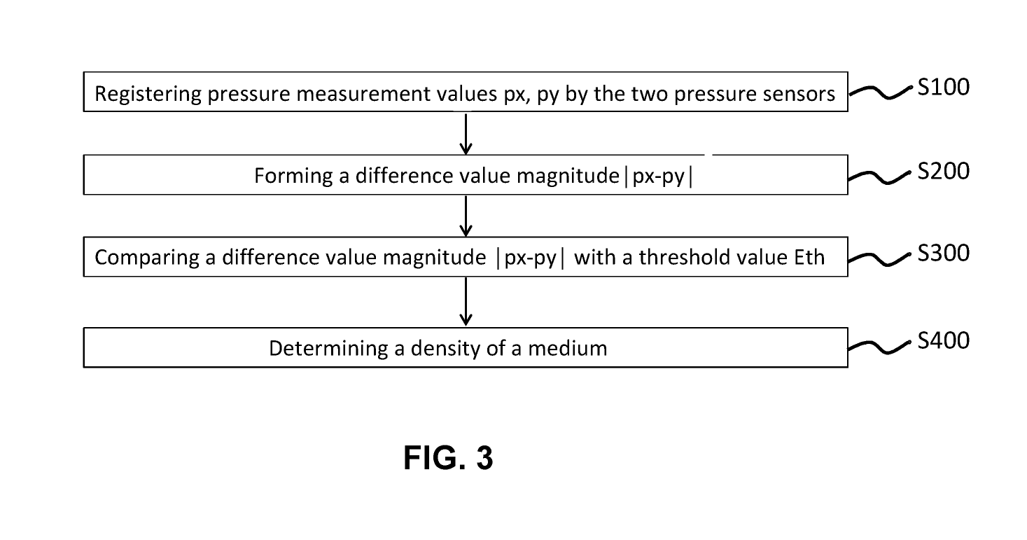

FIG. 3 shows a schematic representation of the method of the present disclosure using the example of two pressure sensors. In the case, in which more than two pressure sensors are used, such as above described, those pressure measurement values px, py of two pressure sensors 2 are evaluated, which have measuring ranges nearest the current tank level, or pressure measurement value.

The method provides in a first method step S100 that, for more exact determining of the density of the medium, first pressure measurement values px, py of two pressure sensors are registered. In the next method step S200, a difference value magnitude |px−py| is formed from the previously registered pressure measurement values. This is then compared in method step S300 with a threshold value Eth, in order then in method step S400 to ascertain the density of the medium based on the result of the comparing of the difference value with the threshold value. For this, there occurs in step S400 the changing of which is the active sensor, in the case of rising fill level, upon the exceeding of the threshold value Eth and, in the case of sinking fill level, upon the subceeding of the threshold value. In the case, in which one uses a first pressure sensor px with a first measuring range and a second pressure sensor py with a second measuring range, which is greater than first measuring range, there results, mathematically expressed, the following:

When |px−py|>Eth, then the density is calculated according to the Equation, ρ=py/(g*h), and when |px−py|≤Eth, then the density is calculated according to the Equation, ρ=px/(g*h).

In order to enable a more targeted changing of which is the active sensor, an offset can be formed, which represents a separation between the characteristic lines extending parallel to one another. The offset can be determined once, for example, upon start-up of the pressure sensors, or of the HTMS. The offset O makes a deviation of the parallelness detectable and thus enables a more targeted changing of which is the active sensor. The method changes, mathematically considered, thus as follows:

When ∥px,current−py,current|−O|>Eth, then the density is calculated according to the Equation, ρ=py/(g*h), and when ∥px,currently−py,currently|−O|≤Eth, then the density is calculated according to the Equation, ρ=px/(g*h), wherein the offset is defined as O=|px,parallel−py,parallel|.

The threshold value Eth is composed of the absolute measurement errors of the pressure sensors. The absolute measurement errors Δpx, Δpy for the particular pressure measuring ranges of the particular pressure sensors are specified in such a manner such that they include at least one reference accuracy E1 and one environmental temperature influence variable E2 of the particular pressure sensors, preferably according to the formula Δpx, or Δpy=±√(E12+E22). The reference accuracy E1 includes a non-linearity according to DIN EN 61298-2:2009-08 with reference to the particular pressure measuring range according to the limiting point method of DIN EN 60770:2011-09. The non-linearity includes, in turn, a hysteresis according to DIN EN 61298-2:2009 and a non-reproducibility according to DIN EN 61298-2:2008. The environmental temperature influence variable E2 includes at least one influence of an ambient temperature according to IEC 61298-3:2009-08 at a reference temperature, preferably 25° C., according to DIN 16086:2006-01.

In principle, used as threshold value Eth can be the absolute measurement error of one of the two pressure sensors or an average value or a root mean square average value of the two absolute measurement errors.

Proved as advantageous, however, has been when the absolute measurement error of the pressure sensor with the lesser absolute measurement error is used as threshold value Eth. Usually, this means that the pressure sensor with the lesser measuring range is selected, since the absolute measurement error is with reference to the measurement end value of the pressure sensor.

1. A method for determining a density of a medium in a tank, comprising:
providing a hybrid tank measurement system having at least a first pressure sensor and a second pressure sensor having mutually differing pressure measuring ranges, the first pressure sensor having a first absolute measurement error and the second pressure sensor having a second absolute measurement error;
registering a first pressure value using the first pressure sensor and a second pressure value using the second pressure sensor;
calculating a pressure difference magnitude from the difference between the first pressure value and the second pressure value;
comparing the pressure difference magnitude with a threshold value; and
determining the density of the medium based on the comparing of the pressure difference magnitude with the threshold value.

2. The method as claimed in claim 1, wherein when the pressure difference magnitude is greater than the threshold value, the pressure value of the pressure sensor having a greater absolute measurement error is used for determining density, and when the pressure difference magnitude is less than the threshold value, the pressure value of the pressure sensor having a lesser absolute measurement error is used for determining density.

3. The method as claimed in claim 1, wherein an offset value is used in the comparing of the pressure difference magnitude with the threshold value, and wherein the offset value represents a deviation of at least the first pressure value or the second pressure value from a reference point, including a zero-point.

4. The method as claimed in claim 3, wherein the comparing of the pressure difference magnitude with the threshold value in which the offset value is used and the determining of the density of the medium are performed such that when the pressure difference magnitude minus the offset value is greater than the threshold, the pressure value of the pressure sensor having a greater absolute measurement error is used for determining density and when the pressure difference magnitude minus the offset is less than the threshold, the pressure value of the pressure sensor having a lesser absolute measurement error is used for determining density.

5. The method as claimed in claim 1, wherein a lesser of the first absolute measurement error and the second absolute measurement error is used as the threshold value.

6. The method as claimed in claim 1, wherein the determining of density of the medium is performed based on the following equations:
ρ=px/(g*h), or ρ=py/(g*h),
wherein ρ is the determined density, px is the first pressure value, py is the second pressure value, g is the acceleration of gravity, and h is a fill level of the tank.

7. The method as claimed in claim 6, further comprising:
correcting the fill level using an offset of the corresponding pressure sensor.

8. The method as claimed in claim 1, wherein the absolute measurement error of each pressure sensor is determined from a square root of a sum of a reference accuracy of the respective sensor and an environmental temperature influence variable of the respective pressure sensor.

9. The method as claimed in claim 8, wherein the reference accuracy of each pressure sensor includes a non-linearity according to DIN EN 61298-2:2009-08 in a pressure measuring range according to a limiting point method of DIN EN 60770:2011-09, and wherein the non-linearity is influenced by a hysteresis according to DIN EN 61298-2:2009 and a non-reproducibility according to DIN EN 61298-2:2008.

10. The method as claimed in one by claim 8, wherein each environmental temperature influence variable includes at least one influence of an ambient temperature according to IEC 61298-3:2009-08 at a reference temperature of 25° C., according to DIN 16086:2006-01.

11. A hybrid tank measurement system, comprising:
a first pressure sensor having a first measure range;
a second pressure sensor having a second measuring range, wherein the first measuring range and the second measuring range partially overlap;
a level-measuring device;
a temperature sensor; and
a processor embodied to configure and to control the first pressure sensor, the second pressure sensor, the level measuring device, and the temperature sensor, the processor further configured to:
register a first pressure value using the first pressure sensor;
register a second pressure value using the second pressure sensor;
calculate a pressure difference magnitude from the difference between the first pressure value and the second pressure value;
compare the pressure difference magnitude with a threshold value; and
determine the density of the medium based on the comparing of the pressure difference magnitude with the threshold value.
